(19) United States
(12) Patent Application Publication
(10) Pub. No.: US 2016/0106044 A1
(43) Pub. Date: Apr. 21, 2016

(54) Plant Container for Holding a Growing Medium in Which One or More Plants Can Grow

(71) Applicant: iBOP Ltd., Cheadle Hulme (GB)

(72) Inventor: Alan Markham, Cheadle Hulme (GB)

(21) Appl. No.: 14/515,208

(22) Filed: Oct. 15, 2014

(51) Int. Cl. A01G 9/02; A01G 27/00

(52) U.S. Cl. CPC A01G 9/02; A01G 27/00

(57) ABSTRACT

A plant container includes: an outer receptacle that includes at least one drain hole in its base; an inner receptacle that fits inside the outer receptacle, the inner receptacle including at least one feeding hole in its base; a sealing element located between the outer receptacle and inner receptacle, wherein the sealing element extends around the at least one feeding hole and the at least one drain hole so as to provide a seal between the outer receptacle and the inner receptacle when the inner receptacle sits on the sealing element; and an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle.

### FIELD OF THE INVENTION

This invention relates to a plant container for holding a growing medium in which one or more plants can grow.

### BACKGROUND

For plants to flourish they must be provided with the correct amount of moisture. In general, providing a plant with too little or too much fluid (usually water, which may optionally contain other matter such as plant food) will compromise the plant's growth and life span.

The correct amount of fluid varies not only among different types of plants but with the particular environment in which the plant is growing. It is a time consuming and laboured process to manually supply the necessary fluids. An automatic device providing the necessary moisture to the plant is therefore thought by the inventor to be desirable, especially if the fluid is dispensed on demand.

Fluid dispensing plant containers fall into different categories. Some use fluid administered by pipes. Some have porous inner containers where the fluid seeps through a container wall. Others have a reservoir located in the base of the container which relies on capillary action or fabric wicks to deliver the fluid to a growing medium from the reservoir. None of these categories of plant containers use hydrostatic pressure and buoyancy aiding fluid delivery or a delivery valve.

Some self-regulating automatic dispensing plant containers incorporate vacuum sealed reservoirs located within the container wall, using a sensor located within a growing medium to activate the flow of fluid through apertures in the bottom of the plant container. With this type of plant container, it is essential that a flexible stopper used to fill the reservoir is tightly sealed thus maintaining the vacuum within.

This patent application builds upon previous patent applications GB2480500, GB2507318 and WO2014/068273 by the same inventor. These previous patent applications sought to provide a self-regulating plant container which overcame or ameliorated problems with the devices described above, with a view to providing a plant container both simple in operation and production.

In GB2480500, there was disclosed a self-watering plant container comprising an inner receptacle placed inside a larger receptacle separated by a valve. The gap between the two receptacles forms a reservoir into which fluid is introduced. If the weight of the inner receptacle and contents is less than a certain value, the inner receptacle floats, opening the valve to allow fluid ingress from the reservoir through an aperture in the inner receptacle, aided by hydrostatic pressure. If the weight of the inner receptacle and contents is greater than a certain value, the inner receptacle will counteract the buoyancy effect enabled by the reservoir gradually lowering the inner receptacle back onto the valve creating a seal, thus preventing fluid flow.

In GB2507318 and WO2014/068273, there was disclosed a self-watering plant container similar to that disclosed in GB2480500, but which additionally included a drain screw connected to the larger (outer) receptacle to allow the inner receptacle to freely drain in excessively wet conditions should the plant container be used outdoors.

The present inventor has observed that whilst the plant container of GB2507318 and WO2014/068273 permits the plant container to be used outdoors, manual effort from a user is required to open the drain screw in the event of excessively wet conditions.

### SUMMARY OF THE INVENTION

The present invention has been devised in light of the above considerations.

A first aspect of the invention may provide:
a plant container for holding a growing medium in which one or more plants can grow, wherein the plant container includes:
an outer receptacle that includes at least one drain hole in its base;
an inner receptacle that fits inside the outer receptacle, the inner receptacle including at least one feeding hole in its base;
a sealing element located between the outer receptacle and inner receptacle, wherein the sealing element extends around the at least one feeding hole and the at least one drain hole so as to provide a seal between the outer receptacle and the inner receptacle when the inner receptacle sits on the sealing element; and
an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle.

The overflow conduit provides a mechanism by which fluid in the inner receptacle flows out through the overflow conduit when the fluid level in the inner receptacle is higher than the outlet of the overflow conduit, without the need for manual effort from a user. Thus, in the event of excessively wet conditions, saturation of any plants in a growing medium contained in the inner receptacle can be avoided.

Preferably, the overflow conduit is a flexible tube. An advantage of a flexible tube is that the level of the outlet in the overflow conduit can be adjusted by cutting the flexible tube at a selected location to provide the outlet in the overflow conduit at that location.

The flexible tube may be attached to an outside wall of the outer receptacle, e.g. using self-adhesive hooks, or by using projections integral with the outside wall of the outer receptacle.

In other embodiments, the overflow conduit may be a duct integrally formed in a wall of the outer receptacle.

Preferably, the inner receptacle contains a growing medium and the outlet in the overflow conduit is below a surface of the growing medium.

Preferably, the outlet in the overflow conduit is 40 mm to 80 mm (more preferably 50 mm to 70 mm, more preferably approximately 60 mm) below the surface of the growing medium.

Preferably, the sealing element is made from a flexible material. Example materials are discussed below. The sealing element may be an o-ring.

Preferably, the base of the outer receptacle has a positioning feature for retaining the sealing element in a predetermined position relative to the outer receptacle. The positioning feature is preferably integrally formed with the base of the outer receptacle and could, for example, be a suitably shaped ridge or depression in the surface of the outer receptacle.

Preferably, the inner receptacle has a positioning feature for accommodating a root barrier element, the purpose of which may be to prevent blockages, e.g. from aggressive root systems.

The inner and/or outer receptacle may be bowl-shaped, preferably with a flat base. Other shapes are equally possible.

The inner and/or outer receptacle may be made of plastic, preferably injection moulded plastic.

Preferably, the inner receptacle contains a growing medium and optionally other content which may include one or more plants.

Preferably, a space between the inner receptacle and the outer receptacle contains fluid which forms a reservoir.

Preferably, a surface of the growing medium is above a level to which the reservoir is filled.

Preferably the reservoir is filled up to the height of the outlet in the overflow conduit, or close to this height. In general, the reservoir need not be filled higher than the outlet in the overflow conduit, since fluid from the reservoir may escape from the outlet in the overflow conduit if filled above this level.

Preferably, the plant container is provided with instructions. The instructions may instruct a user to operate the plant container according to a method described herein.

For example, the instructions may instruct a user to add growing medium to the inner receptacle and/or adjust the overflow conduit such that the outlet in the overflow conduit is 40 mm to 80 mm (more preferably 50 mm to 70 mm, more preferably approximately 60 mm) below a surface of the growing medium.

For example, the instructions may instruct a user to add growing medium to the inner receptacle and/or supply a space between the inner receptacle and the outer receptacle with fluid to provide a reservoir such that a surface of the growing medium is above a level to which the reservoir is filled.

A second aspect of the invention may provide a kit of parts for forming a plant container according to the first aspect of the invention.

A second aspect of the invention may therefore provide:
a kit of parts for forming a plant container for holding a growing medium in which one or more plants can grow, wherein the kit of parts includes:
an outer receptacle that includes at least one drain hole in its base;
an inner receptacle that is configured to fit inside the outer receptacle, the inner receptacle including at least one feeding hole in its base;
a sealing element configured to be located between the outer receptacle and inner receptacle such that the sealing element extends around the at least one feeding hole and the at least one drain hole so as to provide a seal between the outer receptacle and the inner receptacle when the inner receptacle sits on the sealing element;
an overflow conduit that is configured to provide a passage for fluid to flow from the at least one drain hole in the base of the outer receptacle to an outlet in the overflow conduit such that the outlet in the overflow conduit is located between the base of the inner receptacle and the top of the inner receptacle.

Any element of the kit of parts may be as described in connection with the first aspect of the invention.

A third aspect of the invention may provide a method of operating a plant container according to the first aspect of the invention.

A third aspect of the invention may therefore provide:
a method of operating a plant container for holding a growing medium in which one or more plants can grow, wherein the plant container includes: an outer receptacle that includes at least one drain hole in its base;
an inner receptacle that fits inside the outer receptacle, the inner receptacle including at least one feeding hole in its base;
a sealing element located between the outer receptacle and inner receptacle, wherein the sealing element extends around the at least one feeding hole and the at least one drain hole so as to provide a seal between the outer receptacle and the inner receptacle when the inner receptacle sits on the sealing element;
an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle;
wherein the method includes:
putting a growing medium and optionally other content which may include one or more plants in the inner receptacle;
supplying a space between the inner receptacle and the outer receptacle with fluid to provide a reservoir;
wherein if the fluid content of the reservoir is high enough compared with the fluid content of the inner receptacle, then the inner receptacle is caused to lift off the sealing element at least partially thereby allowing at least some fluid from the reservoir to enter the inner receptacle via the at least one feeding hole;
wherein if the fluid level in the inner receptacle is higher than the outlet in the overflow conduit, then at least some fluid from the inner receptacle is caused to exit the plant container by passing through the at least one feeding hole, the at least one drain hole, the overflow conduit, and out from the outlet in the overflow conduit.

The method may include any method step implementing or corresponding to any apparatus feature described in connection with any above aspect of the invention.

A fourth aspect of the invention may provide a method of forming a plant container according to the first aspect of the invention.

A fourth aspect of the invention may therefore provide:
a method of forming a plant container for holding a growing medium in which one or more plants can grow, wherein the method includes:
providing an outer receptacle that includes at least one drain hole in its base;
providing an inner receptacle that includes at least one feeding hole in its base;
providing a sealing element;
fitting the inner receptacle inside the outer receptacle, with the sealing element being located between the outer receptacle and inner receptacle, wherein the sealing element extends around the at least one feeding hole and the at least one drain hole so as to provide a seal between the outer receptacle and the inner receptacle when the inner receptacle sits on the sealing element;
providing an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle.

The method may include any method step implementing or corresponding to any apparatus feature described in connection with any above aspect of the invention.

The invention also includes any combination of the aspects and preferred features described except where such a combination is clearly impermissible or expressly avoided.

### BRIEF DESCRIPTION OF THE DRAWINGS

Examples of the inventor's proposals are discussed below, with reference to the accompanying drawings in which:

FIG. 1 shows a plant container that is in accordance with the present invention as viewed from above.

FIG. 2 shows the plant container of FIG. 1 in cross section with a valve provided by a sealing element that is closed.

FIG. 3 shows the plant container of FIG. 1 in cross section with a valve provided by a sealing element that is open.

FIG. 4 shows an alternative plant container that is in accordance with the teaching of WO2014/068273 as seen from above. This plant container is not an embodiment of the present invention, but is included here for the purposes of better understanding the present invention.

FIG. 5 shows the plant container of FIG. 4 in cross section.

FIG. 6 shows another alternative plant container that is in accordance with the teaching of WO2014/068273 as seen from above. This plant container is not an embodiment of the present invention, but is included here for the purposes of better understanding the present invention.

FIG. 7 shows the plant container from FIG. 6 in cross section.

### DETAILED DESCRIPTION

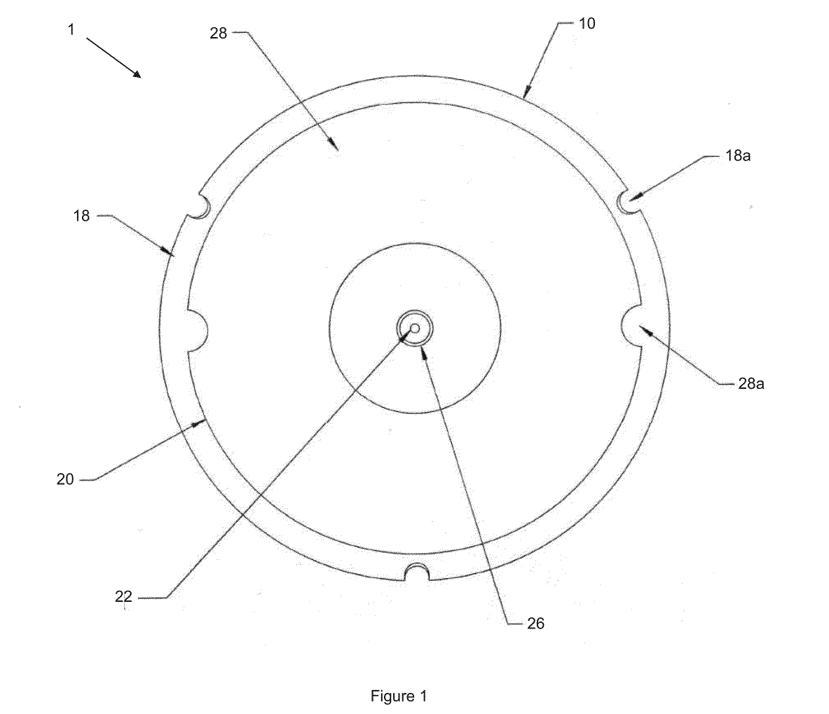

FIGS. 1 to 3 show a plant container 1 (or “plant container”) for holding a growing medium in which one or more plants can grow.

The plant container 1 includes an outer receptacle 10 that includes a drain hole 12 in its base 14; an inner receptacle 20 that fits inside the outer receptacle 10, the inner receptacle 20 including a feeding hole 22 in its base 24; and a sealing element 30 located between the outer receptacle 10 and inner receptacle 20.

The outer receptacle 10 may be made of injection moulded plastic.

The base 14 of the outer receptacle 10 preferably has a positioning feature 16 for retaining the sealing element 30 in a predetermined position relative to the outer receptacle 10. The positioning feature 16 is preferably integrally formed with the base 14 of the outer receptacle.

In the example shown, the positioning feature 16 is a (raised) ring-shaped ridge located centrally with respect to the base 14 of the outer receptacle 10. In some other embodiments (not shown), the positioning feature 16 may be a depression formed in the base 14 of the outer receptacle.

The sealing element 30 extends around the feeding hole 22 and the drain hole 12 so as to provide a seal between the outer receptacle 10 and the inner receptacle 20 when the inner receptacle 20 sits on the sealing element 30.

The sealing element 30 is preferably made of a flexible material. Example materials for the sealing element 30 are discussed below. In the example shown, the sealing element 30 is an o-ring.

Of course, the size and shape of the positioning feature 16 and the sealing element 30 may be varied.

The inner receptacle 20 may be made of injection moulded plastic.

In the example shown, a plurality (in this case three) cut outs 18a are equally spaced around the periphery of a flange 18 of the outer receptacle 10, for allowing the plant container 1 to be suspended, e.g. in a similar manner to a hanging basket.

The inner receptacle 20 preferably has a positioning feature 26 for accommodating a root barrier element 40, the purpose of which is to prevent blockages, e.g. from aggressive root systems.

In the example shown, the positioning feature 26 is a raised ring-shaped ridge located centrally with respect to the base 24 of the inner receptacle 20, and the root barrier element 40 is a loose fitting disc, though of course other configurations are possible.

Without wishing to be bound by theory, the inventor believes that the loose fitting disc allows water from the reservoir 50 to enter into the inner receptacle 20 due to hydrostatic pressure from the reservoir providing a force which acts against the disc allowing fluid to enter the inner receptacle 20 around the periphery of the disc.

Note that the root barrier element 40 has been omitted on some diagrams for clarity.

In the example shown, one or more (in this case two) cut outs 28a are equally spaced around the periphery of a flange 28 of the inner receptacle 20 (see FIG. 1).

The cut outs 28a provide one or more fluid inlets for fluid to be directed into a space between the outer receptacle 10 and the inner receptacle 20.

As will be apparent from the following description, the sealing element 30 provides a valve between the reservoir and the inner receptacle 10.

The inner receptacle 20 is preferably fitted inside the outer receptacle 10 such that the inner receptacle 20 sits on the sealing element 30, allowing the underneath of the inner receptacle 20 to make contact with and sit on the sealing element 30.

A possible method of operating of the plant container 1 will now be described.

Preferably, a growing medium, and optionally other content (which may include one or more plants), is put in the inner receptacle 20. The growing medium 29 may be any medium capable of supporting one or more plants, including (but not limited) to soil, compost, peat, an artificial growing medium or a combination thereof.

Preferably, a space between the inner receptacle 20 and the outer receptacle 10 is supplied with fluid, preferably via the fluid inlets provided by the cut outs 28a, to provide a reservoir 50.

Fluid may also be supplied directly to the growing medium 29 in the inner receptacle 20 until the inner receptacle 20 has a desired fluid content.

The fluid supplied to the inner receptacle 20 and the space between the inner receptacle 20 and the outer receptacle 10 preferably includes water, though may include other content (e.g. plant food). The fluid supplied to the inner receptacle 20 and the space between the inner receptacle 20 and the outer receptacle 10 may come from a fluid source such as rain, a hosepipe or a watering can.

The plant container is preferably configured to operate in two possible states, depending (amongst other parameters) on the water content of the reservoir 50 and the water content of the inner receptacle 20.

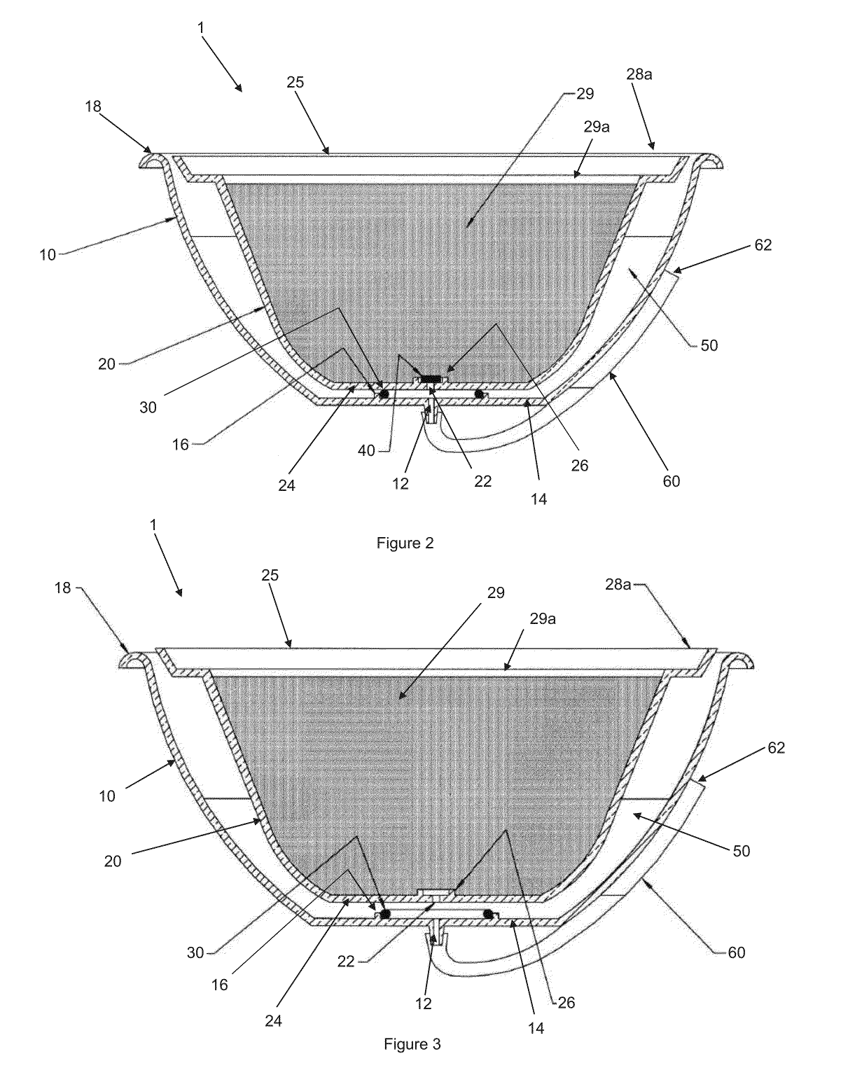

In a first state, shown in FIG. 2, the fluid content of the reservoir 50 is not high enough compared with the fluid content of the inner receptacle 10 to cause the inner receptacle 10 to lift off the sealing element 30, and the weight of the inner receptacle 20 therefore causes the inner receptacle 20 to sit on the sealing element 30.

In this first state, the valve provided by the sealing element 30 can be viewed as being closed, such that fluid from the reservoir 50 is impeded (preferably substantially prevented) from flowing to the inner receptacle 20.

In general, unless fluid is added to the inner receptacle 20 from an external fluid source, the water content of the inner receptacle 20 would be expected to decrease much more quickly than from the reservoir 50 over time, since evaporation from the growing medium 29 and from the one or more plants would generally be expected to be faster than evaporation from the reservoir 50, especially if the reservoir 50 is at least partially covered by a flange 28 of the inner receptacle 20, e.g. as is shown in FIGS. 2 and 3.

Thus, as the fluid content of the inner receptacle 20 decreases, a second state may occur, as shown in FIG. 3.

In the second state, shown in FIG. 3, the fluid content of the reservoir 50 is high enough compared with the fluid content of the inner receptacle 10 to cause the inner receptacle 10 to lift off the sealing element 30 at least partially. Without wishing to be bound by theory, it is thought that the inner receptacle 10 lifting off the sealing element 30 at least partially in these circumstances is caused by hydrostatic pressure of the fluid in the reservoir 50 causing the inner receptacle 20 to float at least partially.

Although, for clarity, FIG. 3 shows the inner receptacle 20 as being fully lifted off the sealing element 30, it is important to note that the inner receptacle 20 might only partially lift off the sealing element 30, since the reduction in weight of the inner receptacle 20 due to evaporation and transpiration is expected to be very gradual such that the valve provided by the sealing element 30 would only need to allow a very small amount of fluid from the reservoir 50 to enter the inner receptacle 20 via the feeding hole 22 before the weight of the inner receptacle 20 increases to allow the inner receptacle 20 to sit back down on the sealing element 30.

In this second state, the valve provided by the sealing element 30 can be viewed as being open, thereby allowing at least some fluid from the reservoir 50 to enter (i.e. be fed to) the inner receptacle 20 via the feeding hole 22.

As fluid enters the inner receptacle 20, the weight of the inner receptacle increases to a value at which the inner receptacle 20 sits back down on the sealing element 30, thereby returning the plant container 1 to the first state in which fluid from the reservoir 50 is impeded (preferably substantially prevented) from flowing to the inner receptacle 20.

The outer and/or inner receptacle 20, 10 is/are preferably solid and non-porous. The outer and/or inner receptacle 20, 10 may be at least partially transparent (e.g. translucent).

For convenience, the height of the inner receptacle 20 is preferably within 10% of the height of the outer receptacle 10, though other height ratios between the inner and outer receptacle could be conceived.

It is preferred for the outer receptacle 20 to be at least partially transparent, as this permits visual assessment of the fluid level in the reservoir 50. Indeed, visual assessment of the reservoir 50 can also be used to provide an indirect indication of the fluid level in the inner receptacle 20, e.g. a high fluid level in the reservoir 50 may be used as an indication that at least some fluid is present in the inner receptacle 20, e.g. an empty reservoir may be used as an indication that the fluid content of the inner receptacle 20 is low.

Various materials may be used in the manufacture of the outer and inner receptacles 10, 20, e.g. polymers such as polymethyl methacrylate, polycarbonate, acrylic, polyester or styrene acrylonitrile copolymer, which are all solid and translucent.

Various materials offer excellent sealing properties for the sealing element 30, such as Nitrile-butadiene rubber, Chloroprene, and Fluoroelastomers.

As shown in FIGS. 2 and 3, the plant container 1 additionally includes an overflow conduit 60 that provides a passage for fluid to flow from the drain hole 12 in the base 14 of the outer receptacle 10 to an outlet 62 in the overflow conduit 60. The outlet 62 in the overflow conduit 60 is located between the base 24 of the inner receptacle 20 and the top 25 of the inner receptacle 20.

In the example shown, the overflow conduit 60 (which may also be referred to as a “storm drain tube”) is a flexible tube. The flexible tube may be attached to an outside wall of the outer receptacle, e.g. using self-adhesive hooks, or by using projections integral with the outside wall of the outer receptacle.

In the example shown, the flexible tube is pushed onto a connector integrally formed with the base 14 of the outer receptacle 10 at the drain hole 12, to provide fluid connection between the drain hole 12 and the flexible tube.

In other embodiments (not shown), the overflow conduit 60 may be a duct integrally formed in a wall of the outer receptacle 10.

Preferably, if the fluid level in the inner receptacle 20 is higher than the outlet 62 in the overflow conduit 60, then at least some fluid from the inner receptacle 20 is caused to exit the plant container 1 by passing through the feeding hole 22, the drain hole 12, the overflow conduit 60, and out from the outlet 62 of the overflow conduit 60. Without wishing to be bound by theory, it is thought that the fluid from the inner receptacle 20 in these circumstances is caused to exit the plant container 1 by hydrostatic pressure of fluid in the inner receptacle 10.

Thus, the overflow conduit 60 provides a mechanism by which fluid in the inner receptacle 20 flows out through the overflow conduit 60 when fluid in the inner receptacle 20 is higher than the outlet 62 of the overflow conduit 60, without the need for manual effort from a user.

So, should the plant container 1 be used outdoors during excessively wet conditions, any excess water held in the inner receptacle 20 can automatically exit the plant container 1 via the overflow conduit 60, thereby preventing any plants contained in the plant container 1 from becoming overly-saturated with fluid.

Note that in the second state shown in FIG. 3, fluid from the reservoir 50 can flow out of the plant container 1 via the drain hole 12 (i.e. in addition to water from the reservoir 50 being fed into the inner receptacle 20), if the fluid level of the reservoir is above the outlet 62 of an overflow conduit 60. Therefore, some fluid from the reservoir 50 may be lost in this way whilst the reservoir is filled above the outlet 62. For this reason, the height of the outlet 62 in the overflow conduit 60 above the base 22 of the inner receptacle 20 is preferably chosen to be high enough such that an adequate amount of water can held in the reservoir 50 below the level of the outlet 62, yet low enough to prevent the fluid level in the inner receptacle from becoming too high during excessively wet conditions.

In practice, it has been found that the plant container 1 works well if the outlet 62 is below a surface 29a of the growing medium 29 in the inner receptacle 20, since this helps prevent the growing medium 29 from becoming unnecessarily saturated (plant roots need to ‘breathe’ and saturation can kill plants quickly), whilst helping to avoid the loss from the plant container 1 of fluid that might subsequently be useful (e.g. if rain that was causing the growing medium 29 to become saturated were to stop).

The surface 29a of the growing medium may be referred to as an “upper” surface of the growing medium, since it is generally at the top of the growing medium when the plant container 1 is put in an upright position.

Preferably, the outlet 62 is 40 mm to 80 mm below the surface 29a of the growing medium 29, more preferably 50 mm to 70 mm below the surface 29a of the growing medium 29, since the inventor has found that this helps to ensure that plant roots in a band above the level of the outlet 62 avoid saturation. The inventor has found that an outlet 62 that is approximately 60 mm below the surface 29a of the growing medium 29 is highly preferred.

In use, the growing medium 29 is preferably added so that a surface 29a of the growing medium 29 is above a level to which the reservoir 50 is filled, since the inventor has found that this results in satisfactory operation of the plant container 1.

Preferably the reservoir 50 is filled up to the height of the outlet 62 in the overflow conduit 60. In general, the reservoir 50 need not be filled higher than the outlet 62 in the overflow conduit 60, since fluid from the reservoir 50 may escape from the outlet 62 in the overflow conduit 60 if filled above this level.

As would be appreciated by a skilled person, the shape and relative sizes of the outer and inner receptacles 10, 20 and the height of the outlet 62 in the overflow conduit 60 may be varied according to the intended application of the plant container 1 and/or user preference.

In general, the inventor believes that most sizes/shapes of outer and inner receptacles 10, 20 will provide a working plant container 1, provided that the outer and inner receptacles 10, 20 are shaped/sized such that the reservoir 50 can be filled to at least a height at which the reservoir 50 can lift a fully laden (i.e. a moist but not saturated) inner receptacle 20 off the sealing element 30, e.g. through a buoyancy force.

In general, the inventor believes that the inner receptacle 20 can have a wide variety of shapes, so long as the inner receptacle 20 has a shape that is capable of being isolated from the reservoir 50 when sitting on the sealing element 30, whilst allowing fluid to enter from the reservoir 50 (via the feeding hole 22) when lifted off the sealing element 30.

The plant container 1 may be configured for use as a hanging basket, e.g. by providing the plant container 1 with one or more hanging elements, such as chains.

However, the plant container 1 may equally be configured for a variety of different environments. For example, the plant container 1 could be configured to be attached to a wall, or as a free standing plant container to be located on the floor or upon furniture (such as a table). The plant container 1 could be configured to locate itself into a variety of stands utilising a protrusion on the outside of the outer receptacle for alignment.

A variety of shapes may be used for the inner receptacle 20 and/or outer receptacle 10, e.g. cylindrical, conical, hexagonal or square.

In the example of the plant container 1 being configured for use as a hanging basket to be used indoors, the user would benefit from the knowledge that there would be no spillage as is the case with wire type hanging plant containers. If used as a hanging basket, the present invention could potentially save fluid spills due to zero leakage, unlike some hanging baskets where excessive spills are unavoidable.

Many free standing plant containers of the type used commercially in offices, restaurants and the like, are usually large by nature, and often have no visual means to observe fluid levels bringing the problem of uncertainty regarding the moisture content of the a growing medium resulting in unhealthy plants. Often plastic plants are used in such containers, such is the problem with fluid control.

Fluid addition to plant containers is usually from above, but the plant container 1 is able to introduce fluid from below, resulting in the plant container 1 being saturated in the lower section and drier in the top section of the plant container 1. This helps to reduce evaporation to atmosphere from the surface of the growing medium 29. This could be deemed a water saving feature.

In use, plant food could be introduced directly into the reservoir 50 avoiding the possibility of spillage compared with if the plant food were introduced to the plant container 1 conventionally from above.

In some embodiments, multiple plant containers 1 being watered from one source could be connected by lengths of tubing connecting between the reservoirs 50. In this case, fluid could cascade from plant container to plant container until all reservoirs 50 are replenished. This system could be automated by fitting a simple ball cock valve to the final plant container.

If the material of the outer receptacle 10 is opaque (e.g. to permit possibly more aesthetic materials of an opaque nature), then it may be difficult to ascertain the water level of the reservoir 50.

In this case, the plant container 1 may include, for example, a floating dipstick or an at least partially transparent conduit extending from an outlet in the outer receptacle 10 in or near to the base 14 of the outer receptacle 10, to provide a gauge of the water level of the reservoir 50. Unlike the overflow conduit 60, the at least partially transparent conduit should connect to the outer receptacle 10 outside of the sealing element 30, so as to connect the at least partially transparent conduit to the reservoir 50.

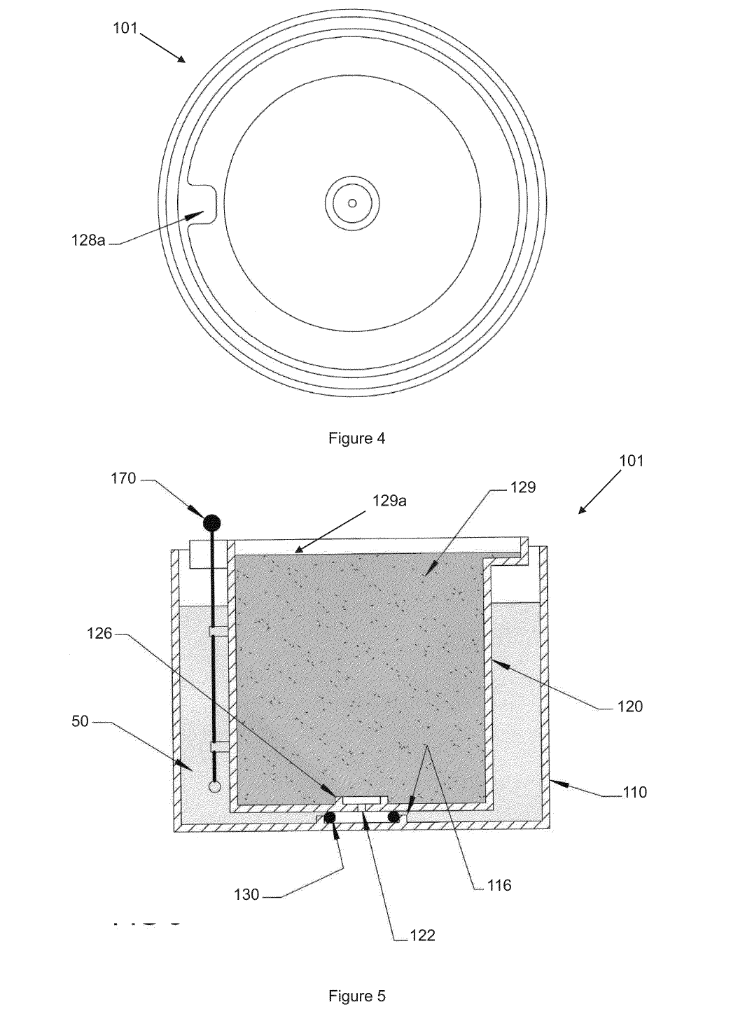

FIGS. 4 and 5 illustrate an alternative plant container 101 that incorporates an example floating dipstick 170, which could be incorporated into the plant container 1 of FIGS. 1 to 3.

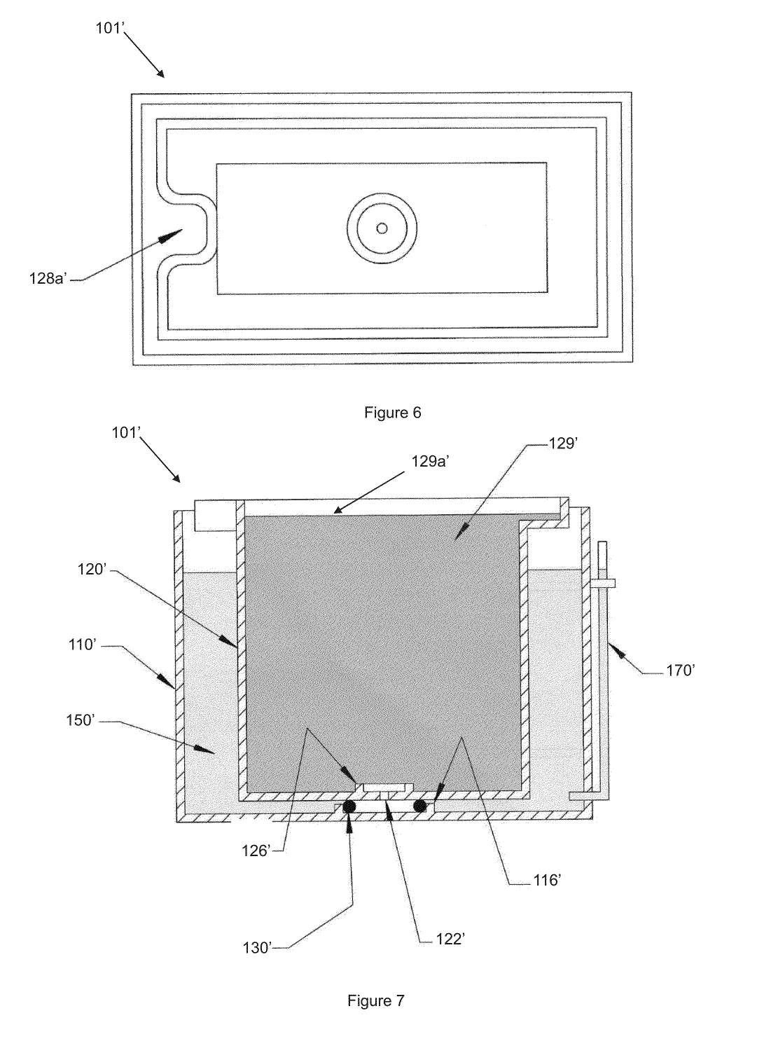

FIGS. 6 and 7 illustrate another alternative plant container 101′ that incorporates an example at least partially transparent conduit 170′, which could be incorporated into the plant container 1 of FIGS. 1 to 3.

Note that in FIGS. 4 to 7, features corresponding to those already explained are given alike reference numerals and need not be explained in further detail.

In use, the plant container 1 could negate the requirement of a translucent outer receptacle 10 allowing, possibly more aesthetic materials of a non-translucent nature to be used. A transparent tube could be attached to the side of the plant container entering beneath, e.g. to provide indication of fluid level within the reservoir and by default the moisture content of the inner receptacle 20, e.g. as described above with reference to FIGS. 4 and 5. Alternatively, a floating dipstick could indicate when the reservoir 50 level is low or empty, e.g. as described above with reference to FIGS. 6 and 7.

The following statements provide general expressions of the disclosure herein.

A. The outlet of a drain tube is located or connected to the exterior of the outer receptacle, said tubes inlet being connected underneath the outer receptacle allowing surplus fluid held within the inner receptacle to freely vent via the plenum located within the valve.
B. A buoyancy operated automatic self-watering plant container according to statement A comprising an inner receptacle disposed inside an outer receptacle, both receptacles being separated by a valve, said valve being retained within a raised ring or depression centrally located inside the base of said outer receptacle, wherein, in use fluid introduced into a void created between said receptacles becomes a reservoir from which the fluid is delivered to the inner receptacle through an aperture in its base.
C. A buoyancy operated automatic self-watering plant container according to statement A where fluid contained within the reservoir flows through the valve into the inner receptacle only when the inner receptacle drops in weight due to evaporation and plant demand lifting the inner receptacle off the valve allowing fluid ingress.
D. A buoyancy operated automatic self-watering plant container according to statement A wherein the valve closes inhibiting fluid ingress when the inner receptacle has increased in weight due to the addition of fluid from the reservoir previously passing through the valve.

When used in this specification and claims, the terms “comprises” and “comprising”, “including” and variations thereof mean that the specified features, steps or integers are included. The terms are not to be interpreted to exclude the possibility of other features, steps or integers being present.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventor does not wish to be bound by any of these theoretical explanations.

All references referred to above are hereby incorporated by reference. In particular, any features described in relation to GB2480500, GB2507318 and WO2014/068273 may be combined with feature disclosed herein, except where such a combination is clearly impermissible or expressly avoided.

1. A plant container for holding a growing medium in which one or more plants can grow, wherein the plant container includes:
an outer receptacle that includes at least one drain hole in its base;
an inner receptacle that fits inside the outer receptacle, the inner receptacle including at least one feeding hole in its base;
a sealing element located between the outer receptacle and inner receptacle, wherein the sealing element extends around the at least one feeding hole and the at least one drain hole so as to provide a seal between the outer receptacle and the inner receptacle when the inner receptacle sits on the sealing element; and
an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle.

2. The plant container of claim 1, wherein the overflow conduit is a flexible tube.

3. The plant container of claim 1, wherein the overflow conduit may be a duct integrally formed in a wall of the outer receptacle.

4. The plant container of claim 1, wherein the inner receptacle contains a growing medium and the outlet in the overflow conduit is 40 mm to 80 mm below a surface of the growing medium.

5. The plant container of claim 1, wherein the inner receptacle contains a growing medium and optionally other content which may include one or more plants, wherein a space between the inner receptacle and the outer receptacle contains fluid which forms a reservoir, and wherein a surface of the growing medium is above a level to which the reservoir is filled.

6. The plant container of claim 1, wherein the plant container is provided with instructions that instruct a user to add growing medium to the inner receptacle and/or adjust the overflow conduit such that the outlet in the overflow conduit is 40 mm to 80 mm below a surface of the growing medium.

7. A kit of parts for forming a plant container for holding a growing medium in which one or more plants can grow, wherein the kit of parts includes:
an outer receptacle that includes at least one drain hole in its base;
an inner receptacle that is configured to fit inside the outer receptacle, the inner receptacle including at least one feeding hole in its base;
a sealing element configured to be located between the outer receptacle and inner receptacle such that the sealing element extends around the at least one feeding hole and the at least one drain hole so as to provide a seal between the outer receptacle and the inner receptacle when the inner receptacle sits on the sealing element;
an overflow conduit that is configured to provide a passage for fluid to flow from the at least one drain hole in the base of the outer receptacle to an outlet in the overflow conduit such that the outlet in the overflow conduit is located between the base of the inner receptacle and the top of the inner receptacle.

8. A method of operating a plant container for holding a growing medium in which one or more plants can grow, wherein the plant container includes:
an outer receptacle that includes at least one drain hole in its base;
an inner receptacle that fits inside the outer receptacle, the inner receptacle including at least one feeding hole in its base;
a sealing element located between the outer receptacle and inner receptacle, wherein the sealing element extends around the at least one feeding hole and the at least one drain hole so as to provide a seal between the outer receptacle and the inner receptacle when the inner receptacle sits on the sealing element;
an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle;
wherein the method includes:
putting a growing medium and optionally other content which may include one or more plants in the inner receptacle; and
supplying a space between the inner receptacle and the outer receptacle with fluid to provide a reservoir;
wherein if the fluid content of the reservoir is high enough compared with the fluid content of the inner receptacle, then the inner receptacle is caused to lift off the sealing element at least partially thereby allowing at least some fluid from the reservoir to enter the inner receptacle via the at least one feeding hole;
wherein if the fluid level in the inner receptacle is higher than the outlet in the overflow conduit, then at least some fluid from the inner receptacle is caused to exit the plant container by passing through the at least one feeding hole, the at least one drain hole, the overflow conduit, and out from the outlet in the overflow conduit.

9. A method of forming a plant container for holding a growing medium in which one or more plants can grow, wherein the method includes:
providing an outer receptacle that includes at least one drain hole in its base;
providing an inner receptacle that includes at least one feeding hole in its base;
providing a sealing element;
fitting the inner receptacle inside the outer receptacle, with the sealing element being located between the outer receptacle and inner receptacle, wherein the sealing element extends around the at least one feeding hole and the at least one drain hole so as to provide a seal between the outer receptacle and the inner receptacle when the inner receptacle sits on the sealing element; and
providing an overflow conduit that provides a passage for fluid to flow from the at least one drain hole in the base of the outer receptacle to an outlet in the overflow conduit, the outlet in the overflow conduit being located between the base of the inner receptacle and the top of the inner receptacle.
